(19) United States
(12) Patent Application Publication
(10) Pub. No.: US 2020/0013008 A1
(43) Pub. Date: Jan. 9, 2020

(54) UNMANNED AIR AERIAL VEHICLE BASED DELIVERY SYSTEM

(71) Applicant: Royce Newcomb, Cameron Park, CA (US)

(72) Inventor: Royce Newcomb, Cameron Park, CA (US)

(21) Appl. No.: 16/573,607

(22) Filed: Sep. 17, 2019

(51) Int. Cl. G06Q 10/08; G05D 1/00; B64C 39/02; A47G 29/14

(52) U.S. Cl. CPC G06Q 10/0832; G06Q 10/0833; G05D 1/0088; G05D 1/0022; B64C 2201/042; A47G 29/14; B64C 2201/128; B64C 2201/18; B64C 2201/088; B64C 39/024

(57) ABSTRACT

The present disclosure describes an unmanned aerial vehicle (“UAV”) or a drone configured to autonomously deliver an item of inventory to a landing station or destination location. The drone receives inventory information and a destination location and autonomously retrieve the inventory from a source station. The drone is having a GPS module and communication module to communicate with the external devices and the GPS module helps the drone to determine the shortest route to the destination. At the destination location, the landing station has GPS guided lasers which help the drone to deliver the item safely. Further, the landing station also comprises an automatic lithium-ion battery switching system to replace the existing battery of the drone with a freshly charged battery.

### FIELD OF THE INVENTION

The subject matter of the present invention relates generally to a drone or unmanned air aerial vehicle based delivery system and, more particularly, to a GPS laser-guided landing and take-off of a drone when performing delivery and/or pick-up of an item at a designated location.

### BACKGROUND OF THE INVENTION AND THE PRIOR ART

In recent time, the concept of delivery of items through drones and other remote controlled flying delivery devices has emerged. For the optimal implementation of such devices, there is a need to communicate to them a specific location at which to deliver and/or pick-up a parcel or other object. Additionally, there is a need to ensure the security of a parcel that has been delivered or is awaiting pick-up.

Further, drones are convenient for high-speed point-to-point delivery and significantly save cost and labor. But, particularly when performing landing they are prone to damages. Also, the existing drones are vulnerable to damages from malicious actors in the form of theft and damage and destruction of property of the product and the drone itself.

There is a plethora of related devices, some of which contain various aspects that may be applicable in satisfying portions of these needs, but yet leave some crucial elements to which needs to be improved.

One such device is disclosed in U.S. Pat. No. 10,163,177B2 by emmett farris and et.al. The patent discloses a system including a landing location where a drone at least one of delivers and acquires a parcel, and a homing device to interact with the drone to guide the drone to the landing location independent of interaction from another source. The homing device guides the drone during the landing phase of a flight plan.

Another device is disclosed in U.S. Pat. No. 10,124,912B2 by Ryan Walsh and et.al. In this, a landing pad receives and stores packages delivered from an aerial vehicle are awaiting pickup from an aerial vehicle. The landing pad can be placed outside of a window and can contain a transmitter for sending out an identification signal via radio frequency to aid aerial vehicles in finding the landing pad. The landing pad contains a landing platform with a trapdoor that leads to a storage compartment. The trapdoor can be configured to only open when it receives a signal from an authorized aerial vehicle. The storage compartment can be accessed via a storage compartment door which can contain a locking mechanism. The storage compartment can be climate controlled. The landing pad can also have a transmitter that emits sounds to discourage animals from nesting on or near the landing pad. The landing pad can also include a solar power generator as a source of electrical energy.

The major drawback of the above-described devices is landing process of the drone is troubled and not done by pinpoint accuracy causing the risk of damage in drone and the item to be delivered. Another major drawback is the running time of the drone battery if one has to deliver an item to a long distance then the above-described drones will not be able to deliver because the battery cannot run so long.

Therefore, in order to overcome one or more drawbacks associated with the prior art, there is strong felt a need for an improvised drone-based delivery system that is safer, efficient and user-friendly.

### SUMMARY OF THE INVENTION

Few of the objects of the present invention are as stated below:
It is an object of the present invention to provide an advanced drone-based delivery system wherein a drone is landed smoothly and safely;
It is another object of the present invention to provide an advanced drone-based delivery system wherein an item is delivered without any damage to a destination;
It is an additional object of the present invention to provide an advanced drone-based delivery system wherein the system enables the drone to run for a longer time by replacing its existing battery by a freshly charged battery automatically;
It is a further object of the present invention to provide an advanced drone-based delivery system wherein a delivered item stored in a storage compartment is only accessed by an authorized user;
It is still further object of the present invention to provide an advanced drone-based delivery system wherein the system uses GPS guided lasers for better navigation and landing of the drone;
It is still further object of the present invention to provide an advanced drone-based delivery system wherein the drone is made of weather resistant and robust material to avoid any damage from any malicious person or unsocial element;
It is still further object of the present invention to provide an advanced drone-based delivery system wherein the landing station can be mounted at window, wall or any other desired location without any hassle.

Other objects, aspects, features, and goals of the present invention will be better understood from the following detailed description.

Certain embodiments of the present invention is directed to an advanced drone-based delivery system for delivering an item to a user defined location.

Principally, in accordance with a primary aspect of the present invention, the drone-based delivery system comprises a drone or an unmanned aerial vehicle for delivering an item packed in a box, packet or carton made of polythene, thermoplastic, cardboard or any other suitable material. The box includes food, apparels and other goods for the delivery purpose. The system comprises a landing station at the destination location for landing the drone. The landing station is having retractable receiving box, a receiving compartment to receive the item to be delivered by the drone and a storage compartment for storing securely the delivered item.

The system also comprises a communication module which allows the drone to communicate with the landing station. Wherein a user places an order for the item a seller at the source station provides input to the drone about the destination location and instruct the drone to pick up the item to be delivered from the inventory. The drone upon the recipient of input pickups the item from the inventory platform and starts flying towards the destination location. The drone also has a GPS module that follows the shortest route towards the destination location provided by the user. Here, the user and the seller can also track the live location of the drone by using their mobile phone, computer, laptop tablet or any other suitable device. The drone has exact location coordinates of the landing station installed at the user's place. The landing station has a proximity sensor that detects when the drone arrives in the proximity of the landing station. Upon detection of the drone, the retractable receiving box expands outwardly and the integrated delivery grates lift up in a vertical direction via a lifting mechanism to receive the item.

Further, the landing station activates the GPS guided lasers which guides the drone to the landing platform. The landing station emits laser beams and the drone have electronic receivers which receives the signals transmitted by the landing station via laser beams and follows the laser beams till the landing. The drone easily lands on the landing platform by following laser guides.

Once the drone landed on the landing platform the drone releases the item on the integrated delivery grates. The drone after releasing the item on the integrated delivery grates follows the same GPS guided laser beams and take off. Once the drone takes offs safely the retractable receiving box starts retracing back and the item automatically goes to a storage compartment situated at the back side of the retractable receiving box. Here, the user can open the storage compartment and collect the item from the integrated delivery grates.

According to another aspect of the present invention, the landing station also has an automatic lithium-ion battery switching system. The lithium-ion battery switching system has a freshly charged battery on standby. When the drone reaches the landing platform a sensor detects the battery percentage of the drone, and if the battery percentage is not enough to reach the next destination of the drone the automatic lithium-ion battery switching system replaces the existing battery of the drone by the freshly charged battery.

The foregoing has outlined, rather broadly, the features and technical advantages of the present invention in order that the detailed description of the invention that follows may be better understood. Additional features and advantages of the invention will be described hereinafter which form the subject of the claims of the invention. It should be appreciated that the conception and specific embodiment disclosed may be readily utilized as a basis for modifying or designing other structures for carrying out the same purposes of the present invention. It should also be realized that such equivalent constructions do not depart from the invention as set forth in the appended claims. The novel features which are believed to be characteristic of the invention, both as to its organization and method of operation, together with further objects and advantages will be better understood from the following description when considered in connection with the accompanying figures. It is to be expressly understood, however, that each of the figures is provided for the purpose of illustration and description only and is not intended as a definition of the limits of the present invention.

### BRIEF DESCRIPTION OF THE ACCOMPANYING DRAWINGS

Embodiments of the present disclosure will be described more fully hereinafter with reference to the accompanying drawings in which like numerals represent like elements throughout the figures, and in which example embodiments are shown:

FIG. 1 illustrates a front view of a landing station installed at a window in accordance with a most preferred embodiment of the present invention;

FIG. 2 illustrates a back side view of the landing station installed at the window in accordance with the most preferred embodiment of the present invention;

FIG. 3 illustrates a side perspective view of the landing station in an extended position in accordance with the most preferred embodiment of the present invention;

FIG. 4 illustrates a top perspective view of the landing station in the extended position in accordance with the most preferred embodiment of the present invention;

FIG. 5 illustrates a top perspective view of the landing station in the extended position in accordance with the most preferred embodiment of the present invention;

FIG. 6 Illustrate a front perspective view of a drone in accordance with the most preferred embodiment of the present invention;

FIG. 7 Illustrates a side perspective view of the landing station when the drone is in the proximity of the landing station in accordance with the most preferred embodiment of the present invention;

FIG. 8 Illustrates a side perspective view of the landing station when the drone is following GPS guided lasers in accordance with the most preferred embodiment of the present invention;

FIG. 9 illustrates a side perspective view of the landing station when the drone is landed upon the landing platform, in accordance with the most preferred embodiment of the present invention;

FIG. 10 illustrates a rear perspective view of a retractable receiving box when the drone is landed upon the landing area and ready to release an item to be delivered in accordance with the most preferred embodiment of the present invention; and

FIG. 11 illustrates a back side view when the item is delivered and a user opens a storage compartment to receive the delivered item in accordance with the most preferred embodiment of the present invention.

### DETAILED DESCRIPTION OF THE PREFERRED EMBODIMENTS OF THE PRESENT INVENTION

In order to ameliorate and overcome one or more drawbacks and disadvantages associated with the prior art and to provide additional advantages, an advanced drone-based delivery system is provided and illustrated herein in the form of a non-limiting and exemplary embodiments. Additional features and advantages are realized through the techniques of the disclosure of the present invention. Other embodiments and aspects of the disclosure of the present invention are described in detail herein and are considered a part of the claimed invention.

The detailed description and the drawings illustrate specific exemplary embodiments by which the disclosure may be practiced. These embodiments are described in detail to enable those skilled in the art to practice the disclosure. It is understood that other embodiments may be utilized, and other changes may be made, without departing from the spirit or scope of the present disclosure. The following detailed description is therefore not to be taken in a limiting sense, and the scope of the present disclosure is defined by the appended claims. Embodiments of the claims may, however, be embodied in many different forms and should not be construed as limited to the embodiments set forth herein.

Embodiments of the disclosure are discussed below with reference to the Figures. However, those skilled in the art will readily appreciate that the detailed description given herein with respect to these figures is for explanatory purposes as the disclosure extends beyond these limited embodiments. For example, it should be appreciated that those skilled in the art will, in light of the teachings of the present disclosure, recognize a multiplicity of alternate and suitable approaches, depending upon the needs of the particular application, to implement the functionality of any given detail described herein, beyond the particular implementation choices in the following embodiments described and shown. That is, there are numerous modifications and variations of the disclosure that are too numerous to be listed but that all fit within the scope of the disclosure. Also, singular words should be read as plural and vice versa and masculine as feminine and vice versa, where appropriate, and alternative embodiments do not necessarily imply that the two are mutually exclusive.

It is to be further understood that the present disclosure is not limited to the particular methodology, compounds, materials, manufacturing techniques, uses, and applications, described herein, as these may vary. It is also to be understood that the terminology used herein is used for the purpose of describing particular embodiments only, and is not intended to limit the scope of the present disclosure. It must be noted that as used herein and in the appended claims, the singular forms “a,” “an,” and “the” include the plural reference unless the context clearly dictates otherwise. Thus, for example, a reference to “an element” is a reference to one or more elements and includes equivalents thereof known to those skilled in the art. Similarly, for another example, a reference to “a step” or “a means” is a reference to one or more steps or means and may include sub-steps and subservient means.

Unless defined otherwise, all technical and scientific terms used herein have the same meanings as commonly understood by one of ordinary skill in the art to which this disclosure belongs. Preferred methods, techniques, devices, and materials are described, although any methods, techniques, devices, or materials similar or equivalent to those described herein may be used in the practice or testing of the present disclosure.

References to “one embodiment,” “an embodiment,” “example embodiment,” “various embodiments,” etc., may indicate that the embodiment(s) of the disclosure so described may include a particular feature, structure, or characteristic, but not every embodiment necessarily includes the particular feature, structure, or characteristic. Further, repeated use of the phrase “in one embodiment,” or “in an exemplary embodiment,” do not necessarily refer to the same embodiment, although they may.

The foregoing descriptions of specific embodiments of the present disclosure have been presented for purposes of illustration and description. They are not intended to be exhaustive or to limit the invention to the precise forms disclosed, and obviously many modifications and variations are possible in light of the above teaching.

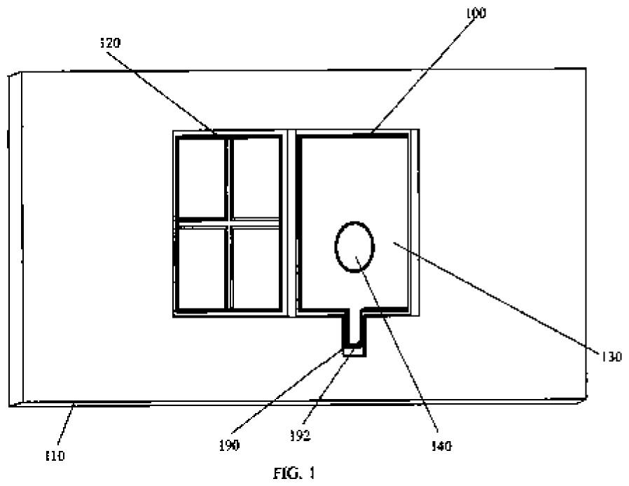

Referring to FIG. 1 to FIG. 11, a drone-based delivery system is described in accordance with a most preferred embodiment of the present disclosure. The drone-based delivery system comprises a drone 200, a landing station 100 and an item 210 to be delivered. The landing station 100 comprises a retractable receiving box 160, a storage compartment 150 and an automatic sliding mechanism 190. The retractable receiving box 160 is having a receiving compartment 161 for receiving the item 210 to be delivered by the drone 200.

The drone 200 comprises a communication module 240 which allows the drone to communicate with the landing station 100. The landing station 100 also comprises a communication module (Not Shown). When a user (not shown) places an order for the item 210 a seller at the source station provides input to the drone 200 about the destination location and instruct the drone 200 to pick up the item 210 to be delivered from an inventory. The drone 200 upon the recipient of input pickups the item 210 from the inventory platform (Not Shown) and starts flying towards the destination location. The drone 200 also has a GPS module (Not Shown) that follows the shortest route towards the destination location provided by the user. Here, the user and the seller can also track the live location of the drone 200 by using their mobile phone, computer, laptop tablet or any other suitable device. The drone 200 has exact location coordinates of the landing station 100 installed at the user's place. The landing station 100 has a proximity sensor (Not Shown) which can identify when the drone arrives in the proximity of the landing station 100. Upon detection of the drone 200 the retractable receiving box, 160 expands outwardly and an integrated delivery grate 170 mounted inside the receiving compartment 161 lifts vertically in an upward direction to receive the item 210.

Further, the landing station 100 activates a GPS guided laser 180 which guides the drone 200 to a landing platform 162. When the landing station 100 activates GPS guided laser 180 electronic receivers mounted inside the drone 200 receives the signals transmitted by the landing station 100 via GPS guided lasers 180 and follows the signals for a safe landing. The drone 200 easily lands on the landing platform 162 by following the GPS guided lasers 180.

Once the drone 200 landed on the landing platform 162 the drone 200 releases the item 210 on the integrated delivery grate 170. The drone 200 after releasing the item 210 on the integrated delivery grate 170 follows the GPS guided lasers 180 to take off. Once the drone 200 takeoffs safely the retractable receiving box 160 starts retracing back and item 210 automatically goes to a storage compartment 150 situated at the back side of the retractable receiving box 160. The user can open the storage compartment 150 and collect the item 210 from the integrated delivery grate 170.

Referring to FIG. 1, a front view or exterior view of the landing station 100 is shown. Wherein the landing station 100 is mounted on a window 120 of a wall 110. The sliding mechanism 190 is situated at the bottom side of the retractable receiving box 160. The sliding mechanism 190 includes a hollow box 191 having tracks on which a part 192 which is abutted to the bottom of the retractable receiving box 160 slides outwardly and inwardly. Further, an outer surface 130 is completely aligned/flushed with window 120. The outer surface 130 also has a round handle 140 that is used to pull the retractable receiving box 160 manually by a user for maintenance purpose.

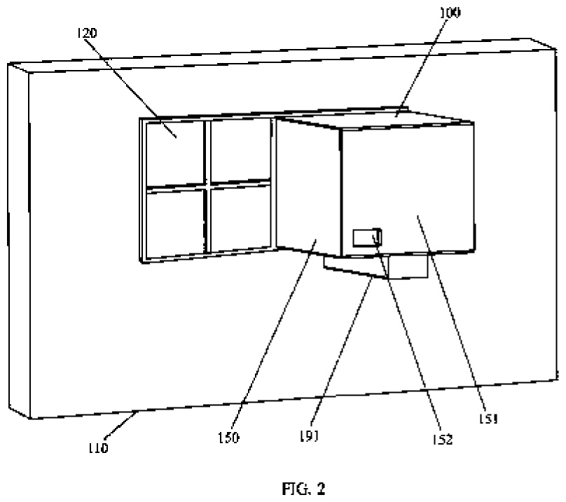

Referring to FIG. 2, a backside view of the landing station 100 is shown. The storage compartment 150 is also having a gate 151 that opens towards the inner side of the wall 110 or inner side of the window 120. The gate 151 also provided with a locking mechanism 152 for preventing unauthorized access to the storage compartment 150. Further, the tail end of the hollow box 191 of the sliding mechanism 190 is also visible.

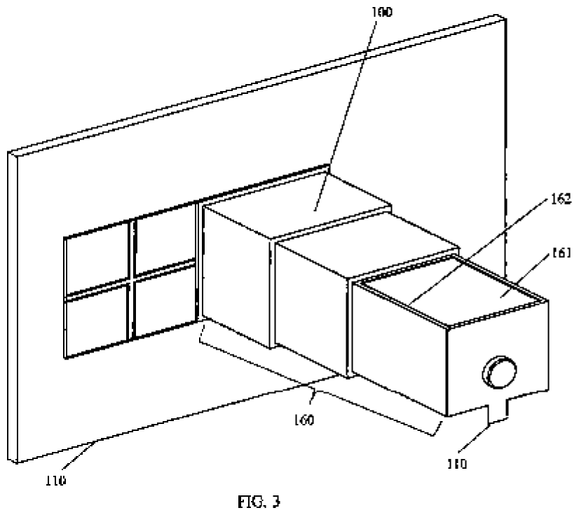

Referring to FIG. 3, a side perspective view of the landing station 100 mounted on the window 120 is shown. The retractable receiving box 160 is shown in the extended position. The receiving compartment 161 is shown with the landing platform 162 situated at the upper edges of the receiving compartment 161 or the upper edges of the receiving compartment 161 itself acting as landing platform 162.

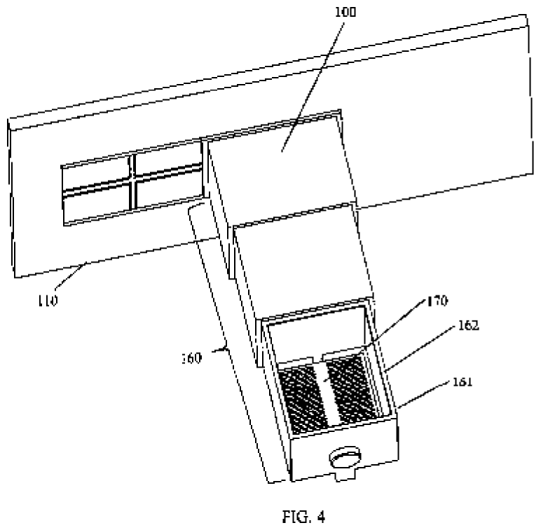

Referring to FIG. 4, a top perspective view of the landing station 100 is shown. Wherein the integrated delivery grate 170 is situated at the bottom of the receiving compartment 161 in the rest position.

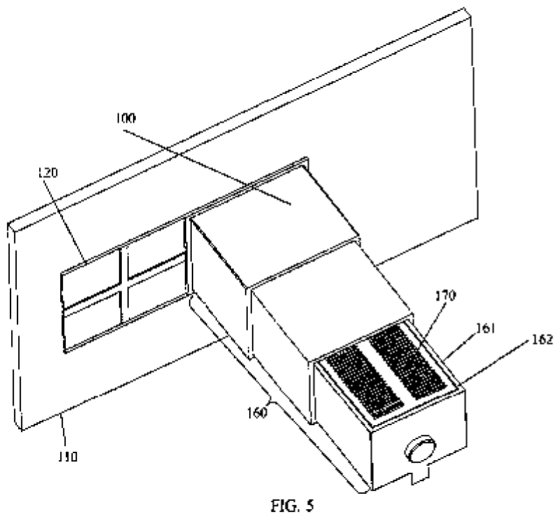

Referring to FIG. 5, a top perspective view of the landing station 100 is shown. Wherein the landing station 100 upon detection of the drone 200 via the proximity sensors (not shown) activated a lift mechanism (not shown) that elevates the integrated delivery grate 170 in a vertical direction within the receiving compartment 161. The integrated delivery grate 170 stops in alignment with upper edges of the receiving compartment 161.

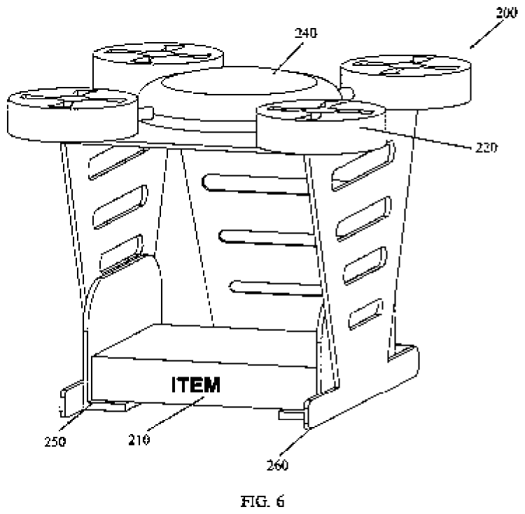

Referring to FIG. 6, a front perspective view of the drone 200 is shown. The drone 200 is comprising a communication module 240, four fans 220 for lifting the drone and a holding mechanism 250 for holding the item 210. The drone 200 is made of robust and weather resistant material so that it can survive in harsh weather conditions. The drone 200 is having four electronic receivers (Not Shown) to receive the GPS guided laser 180 emitted by the landing station 100. The drone body is made of hard material so that it can avoid any chances of damages caused by malicious person and the drone fly high enough to avoid collision with any object come in the way between the source station and the destination station.

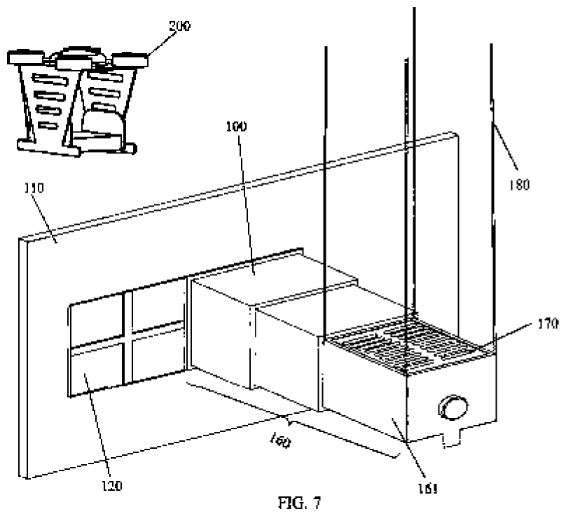

Referring to FIG. 7, a side perspective view of the landing station 100 when the landing station 100 is emitting the GPS guided lasers 180 due to the proximity of the drone 200. Here, the drone 200 is hovering near the landing station 100 as shown in the FIG. 7.

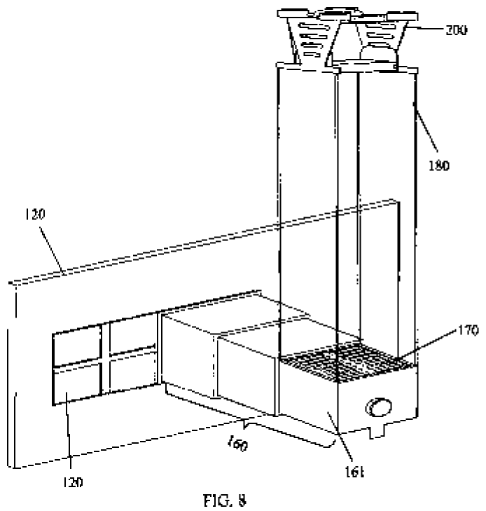

Referring to FIG. 8, a side perspective view of the landing station 100 is shown. Where the drone 200 is hovering exactly upon the landing platform 162 and moving downwardly by following the GPS guided lasers 180.

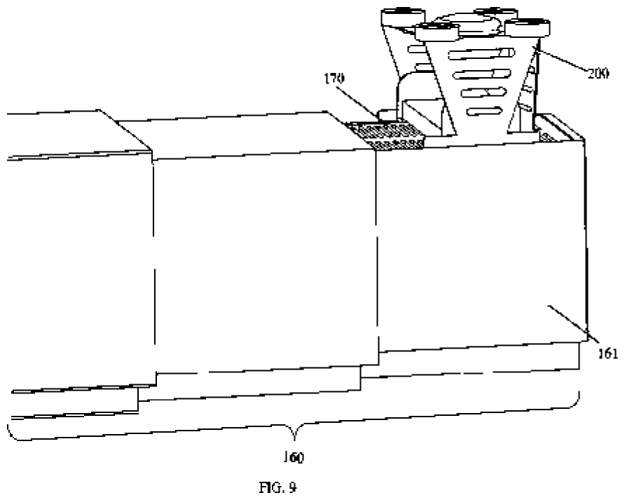

Referring to FIG. 9, a side perspective view of the retractable receiving box 160 is shown. The drone 200 is now landed on the landing platform 162 by aligning its landing base 260 with the landing platform 162.

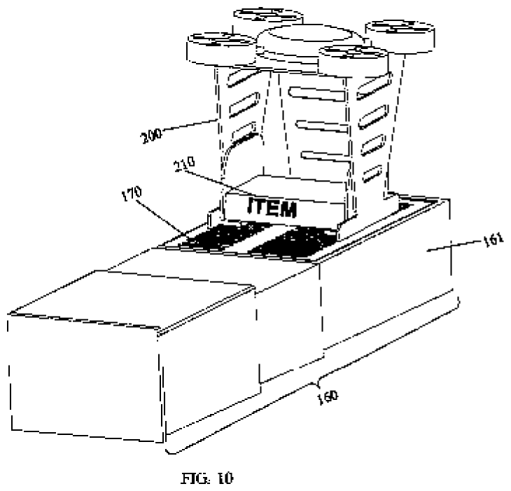

Referring to FIG. 10, a rear side perspective view of the retractable receiving box 160 is shown. The drone 200 is shown in the landing position is now delivering the item 210 on the integrated delivery grate 170. After releasing the item 210 on the integrated delivery grate 170, the drone 200 again follows the GPS guided laser 180 and take off for the next destination or fly back to the source station. Once the drone 200 take off safely the retractable receiving box 160 is start retracting back to the closed position as and attains a position shown in the FIG. 1. When retractable receiving box attains its closed position the integrated delivery grate 170 automatically reaches to the storage compartment.

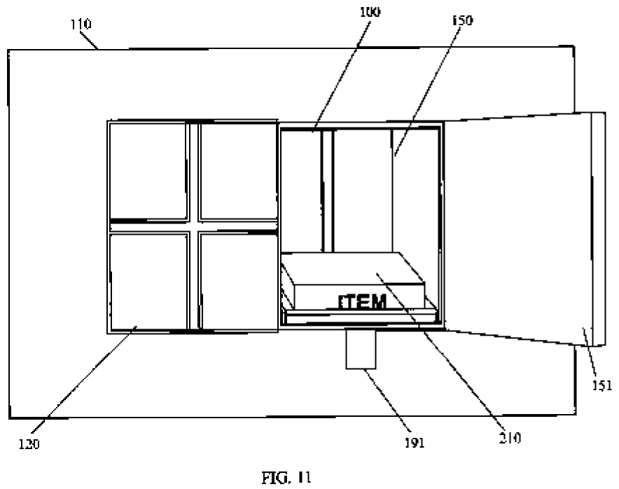

Referring to FIG. 11, a back side view the landing station 100 is shown. The gate 151 of the storage compartment 150 is now opened by the user to collect the delivered item 210 from the storage compartment. To deliver the item 210 to the authorized person the storage compartment is having an authentication mechanism or locking mechanism not limited to a key lock, fingerprint access, face scan or voice recognition system.

According to an advantageous embodiment of the present invention, the landing station 100 may have an automatic lithium-ion battery switching system (not shown). The lithium-ion battery switching system has a freshly charged battery on standby. When the drone 200 reaches at the landing platform 162 a sensor detects the battery percentage of the drone 200, and if the battery percentage is not sufficient to reach the next destination of the drone 200 the automatic lithium-ion battery switching system replaces the existing battery of the drone by the freshly charged battery. So, now the drone 200 never run out of battery in midway.

According to various embodiment of the present disclosure, a user (seller or purchaser) can control and track the movement of the drone at any time during the delivery.

According to various embodiment of the present disclosure, landing station can be mounted at a window, a wall or any other desired location.

According to various embodiment of the present disclosure, the drone is having electronic receivers which follow said GPS guided laser beams for pin-point accuracy in landing and take-offs.

According to various embodiment of the present disclosure, the drone-based delivery system may use complete autonomous fly-by-wire capability.

Usually, many modifications and other embodiments of the invention will come to the mind of one skilled in the pertinent art having the benefit of the teaching presented in the foregoing descriptions and the associated drawings. Therefore, it is understood that the invention is not limited to the specific embodiments disclosed and that modifications and variations of the disclosed embodiments are intended to be included as readily appreciated by those skilled in the pertinent art. It is contemplated that these modifications and variations be included within the scope and ambit of the instant invention which is defined by the following claims.

We claim:

1. A drone-based delivery system, wherein said system comprising:
a drone delivering an item;
a landing station for landing said drone, wherein said landing station is having a retractable receiving box and a storage compartment to receive said item to be delivered by said drone; and,
wherein said drone and said landing station communicate with each other via a communication module and when said drone is in the proximity of said landing station, said landing station activates GPS guided lasers which provide said drone an exact location coordinates of a landing platform.

2. The drone-based delivery system according to claim 1, wherein said drone is able to hold a box containing said item and fly to a user-defined location.

3. The drone-based delivery system according to claim 1, wherein said landing station can be mounted at a window, a wall or any other desired location.

4. The drone-based delivery system according to claim 1, wherein said retractable receiving box is having an integrated delivery grate inside a receiving compartment for receiving said item.

5. The drone-based delivery system according to claim 4, wherein said integrated delivery grate is capable of moving vertically upward and downward direction with the help of a lift mechanism.

6. The drone-based delivery system according to claim 1, wherein said storage compartment comprises a locking mechanism to restrict unauthorized access to said storage compartment.

7. The drone-based delivery system according to claim 1, wherein said drone is having electronic receivers which follow said GPS guided lasers for pin-point accuracy in landing and take-offs.

8. The drone-based delivery system according to claim 1, wherein said drone communicates with one or more external devices not limited to mobile, laptop, and tablet.

9. The drone-based delivery system according to claim 1, wherein the system uses complete autonomous fly-by-wire capability.

10. The drone-based delivery system according to claim 1, wherein said communication module provides notifications to a user device for various events not limited to arrival of said item, delivery of said item, etc.

11. The drone-based delivery system according to claim 1 and claim 4, wherein said drone lands on said integrated delivery grate and automatically releases said item and prepares to fly back vertically by following said laser guides.

12. The drone-based delivery system according to claim 1, wherein said drone and said landing station is made of weather resistant material.

13. A drone-based delivery system, wherein said system comprising:
a drone delivering an item;
a landing station for landing said drone, wherein said landing station is having a retractable receiving box, a storage compartment and an automatic lithium-ion battery switching system; and,
wherein said drone and said landing station communicate with each other via a communication module and when said drone is in the proximity of said landing station, said landing station activates GPS laser guides which provide said drone an exact location coordinates of a landing platform; and,
wherein said automatic lithium-ion battery switching system removes an existing battery from said drone and installs a freshly charged battery into said drone.

14. The drone-based delivery system according to claim 13, wherein said automatic lithium-ion battery switching system keeps a freshly charged battery on standby so that when said existing battery is not sufficiently charged then said automatic lithium-ion battery switching system replaces said existing battery with said freshly charged battery.
